(19) United States
(12) Patent Application Publication
(10) Pub. No.: US 2015/0218053 A1
(43) Pub. Date: Aug. 6, 2015

(54) MULTILAYER BODY, METHOD FOR MANUFACTURING MULTILAYER BODY, AND METHOD FOR MANUFACTURING POWDER

(71) Applicant: NGK Insulators, Ltd., Nagoya-City (JP)

(72) Inventors: Yoshimasa KOBAYASHI, Nagoya-City (JP); Shinji KAWASAKI, Nagoya-City (JP)

(21) Appl. No.: 14/600,579

(22) Filed: Jan. 20, 2015

Related U.S. Application Data
(60) Provisional application No. 61/935,426, filed on Feb. 4, 2014.

(51) Int. Cl. C04B 35/468; C04B 35/14; B05D 1/12

(52) U.S. Cl. CPC C04B 35/468; B05D 1/12; C04B 35/14

(57) ABSTRACT

In a multilayer body according to the present invention, two or more materials having different dielectric constants are stacked, at least one of the two or more materials having different dielectric constants is composed of particles having a core-shell structure, and the multilayer body is free of glass. In this multilayer body, for example, a first material having a first dielectric constant of 1000 or more and a second material having a second dielectric constant that is lower than the first dielectric constant may be stacked. The first material may be a BaTiO₃ material, and the second material may be one or more selected from the group consisting of BaO—TiO—ZnO materials, BaO—TiO₂—Bi₂O₃—Nd₂O₃ materials, and BaO—Al₂O₃—SiO₂—ZnO materials. The multilayer body may be manufactured by using an aerosol deposition method for spraying a substrate with a raw powder in an atmosphere having a pressure lower than atmospheric pressure.

### BACKGROUND OF THE INVENTION

1. Field of the Invention

The present invention relates to a multilayer body, a method for manufacturing a multilayer body, and a method for manufacturing a powder.

2. Description of the Related Art

Hitherto, various studies have been made on multilayer substrates. For example, it has been proposed to modify a barium titanate dielectric material by the addition of CuO and Bi₂O₃ such that the barium titanate dielectric material can be fired at low temperature and to sinter the barium titanate dielectric material together with a BaO—TiO₂—ZnO ceramic having a low dielectric constant (Patent Literature 1). It is asserted that this can increase bonding strength, suppress delamination or cracking on a bonded surface, and suppress the diffusion of a component at a bonded interface. For example, it has also been proposed to form an interlayer insulating layer of a multilayer substrate at normal temperature by using an aerosol deposition method (AD method) using a fine particle material (Patent Literature 2). It is asserted that this allows the multilayer substrate to be formed at normal temperature and to retain the characteristics of the fine particle material, such as dielectric properties.

PTL 1: Japanese Patent No. 4840935

PTL 2: Japanese Patent No. 4190358

### SUMMARY OF THE INVENTION

However, in a multilayer substrate described in Patent Literature 1, different dielectric materials may react with each other when sintered, and the characteristics of the dielectric materials may deteriorate. Furthermore, it is sometimes difficult to control the shape of the multilayer substrate because of warping resulting from sintering shrinkage and different shrinkage curves of different dielectric materials. Furthermore, the low-temperature firing requires the inclusion of a glass component, which sometimes causes a high dielectric loss. In a multilayer substrate described in Patent Literature 2, the use of the AD method for forming a film by collisions of fine particles may cause deformation of the fine particle material and a decrease in crystallinity, thus resulting in poor dielectric properties, such as a low dielectric constant.

The present invention has been made to solve such problems and principally aims to provide a multilayer body that can retain the dielectric properties of its raw materials.

As a result of extensive studies to solve the problems, the present inventors completed the present invention by finding that a multilayer body in which two or more materials having different dielectric constants are stacked, at least one of the two or more materials having different dielectric constants is composed of particles having a core-shell structure, and which is free of glass can retain the dielectric properties of its raw materials.

In a multilayer body according to the present invention, two or more materials having different dielectric constants are stacked, at least one of the two or more materials having different dielectric constants is composed of particles having a core-shell structure, the multilayer body being free of glass.

A method for manufacturing a multilayer body according to the present invention includes a layering step of successively layering two or more materials having different dielectric constants by using an aerosol deposition method for spraying a substrate with a raw powder in an atmosphere having a pressure lower than atmospheric pressure, wherein a raw powder of at least one of the two or more materials having different dielectric constants in the layering step has a core-shell structure.

A method for manufacturing a powder according to the present invention includes a powder synthesis step of synthesizing a powder having a core-shell structure by adding one or more selected from the group consisting of alkaline-earth elements, rare earth elements, Ti, Sb, Ni, Cu, Cr, Fe, Co, Mn, Ta, Nb, W, Mo, Zn, and Bi to a BaTiO₃ powder and heat-treating the BaTiO₃ powder at a temperature of 500° C. or more and 1300° C. or less.

Amultilayer body and a method for manufacturing the multilayer body according to the present invention can provide a multilayer body that can retain the dielectric properties of its raw materials. A method for manufacturing a powder according to the present invention can manufacture a powder having a core-shell structure more suitable for the manufacture of a multilayer body according to the present invention.

### BRIEF DESCRIPTION OF THE DRAWINGS

FIG. 1 is a schematic explanatory view of the structure of a multilayer body manufacturing apparatus 20.

FIG. 2 is a schematic cross-sectional view of a multilayer body according to Experimental Example 1.

### DESCRIPTION OF THE PREFERRED EMBODIMENTS

(Multilayer Body)

Amultilayer body according to the present invention is a multilayer body in which two or more materials having different dielectric constants are stacked. The two or more materials having different dielectric constants may be a dielectric material. The two or more materials having different dielectric constants may be a ceramic material, such as an oxide ceramic material.

The constituents of a multilayer body according to the present invention are free of glass. In such a multilayer body free of glass, it is possible to suppress the increase in dielectric loss. In a multilayer body according to the present invention, no reaction layer may be formed at an interface between the materials having different dielectric constants by a reaction between the materials. In such a multilayer body, the dielectric properties of each material are retained.

In the multilayer body according to the present invention, a first material having a first dielectric constant of 1000 or more and a second material having a second dielectric constant that is lower than the first dielectric constant may be stacked. In such a multilayer body, a reaction layer is likely to be formed by the diffusion of a component between the first material and the second material in the manufacture of the multilayer body. In the absence of such a reaction layer, the dielectric properties of each material can be retained. The first dielectric constant may be 1100 or more or 1200 or more, for example. The second dielectric constant may be 500 or less, 300 or less, or 150 or less, for example. In such a multilayer body in which a first material and a second material are stacked, the first material may be a BaTiO₃ material, and the second material may be composed of one or more selected from the group consisting of BaO—TiO₂—ZnO materials, BaO—TiO₂—Bi₂O₃—Nd₂O₃ materials, and BaO—Al₂O₃—SiO₂—ZnO materials. The BaTiO₃ material, as used herein, refers to a material containing BaTiO₃ as the main component. The main component refers to a BaTiO₃ content of 50% by mole or more, preferably 70% by mole or more, more preferably 90% by mole or more. Likewise, each of the materials described above as the second material contains the corresponding material as the main component.

In the multilayer body according to the present invention, at least one of two or more materials having different dielectric constants is composed of particles having a core-shell structure. The core-shell structure refers to a structure that includes a material serving as a core and a shell that is formed of a material composed of a different component than the core and covers the core. Being composed of particles having a core-shell structure, the fine particle material can have reduced deformation in the manufacture of a multilayer body, and the dielectric properties, such as the dielectric constant, suffer less deterioration. The core and shell can have different functions and thereby provide greater functionality. In such a multilayer body formed of particles having a core-shell structure, the core of the core-shell structure may have a low aspect ratio than the shell of the core-shell structure (the shell may be flatter than the core). In the manufacture of such a multilayer body, the shell can be preferentially deformed and suppress the deformation of the core, thereby further reducing loss in functionality, such as dielectric properties.

In the multilayer body according to the present invention, a first material having a first dielectric constant of 1000 or more and a second material having a second dielectric constant that is lower than the first dielectric constant may be stacked, and the first material may be composed of particles having a core-shell structure. In the core-shell structure of the first material, the shell may contain one or more selected from the group consisting of alkaline-earth metal elements, rare earth elements, Ti, Sb, Ni, Cu, Cr, Fe, Co, Mn, Ta, Nb, W, Mo, Zn, and Bi. The core-shell structure of the first material preferably has a core composed of BaTiO₃ and a shell composed of BaTiO₃ partly substituted with one or more selected from the group consisting of alkaline-earth metal elements, rare earth elements, Ti, Sb, Ni, Cu, Cr, Fe, Co, Mn, Ta, Nb, W, Mo, Zn, and Bi and/or BaTiO₃ in which one or more selected from the group consisting of alkaline-earth metal elements, rare earth elements, Ti, Sb, Ni, Cu, Cr, Fe, Co, Mn, Ta, Nb, W, Mo, Zn, and Bi is dissolved. BaTiO₃ of the core is formed of tetragonal crystals and is resistant to deformation, and the shell is formed of cubic crystals and is deformable. In the manufacture of a multilayer body, therefore, the shell can be preferentially deformed and suppress the deterioration of the core due to deformation. Thus, the high dielectric constant of BaTiO₃ can be made full use of.

The multilayer body according to the present invention may have an electrically conductive layer. In such a multilayer body having an electrically conductive layer, the electrically conductive layer may contain one or more selected from the group consisting of Ni, Cu, Ag, Pd, Au, and Al. The electrically conductive layer may be formed at an interface between two or more materials having different dielectric constants or may be formed on a surface of at least one of the two or more materials having different dielectric constants. The electrically conductive layer may be entirely or partly formed at the interface or on the surface.

The multilayer body according to the present invention is preferably manufactured by using an aerosol deposition method for spraying a substrate with a raw powder in an atmosphere having a pressure lower than atmospheric pressure. The aerosol deposition method allows each raw powder to be layered without deterioration in the characteristics thereof. The aerosol deposition method requires no heat treatment and therefore facilitates the manufacture of a multilayer body that contains no glass in its materials and does not have a reaction layer formed by a reaction between the materials having different dielectric constants at an interface between the materials. In a multilayer body having an electrically conductive layer, the electrically conductive layer is also preferably formed by using the aerosol deposition method. This allows the raw powder of the electrically conductive layer to be layered without deterioration in the characteristics thereof. Thus, for example, a multilayer body having no reaction layer at an interface between the electrically conductive layer and an adjacent layer can be easily manufactured.

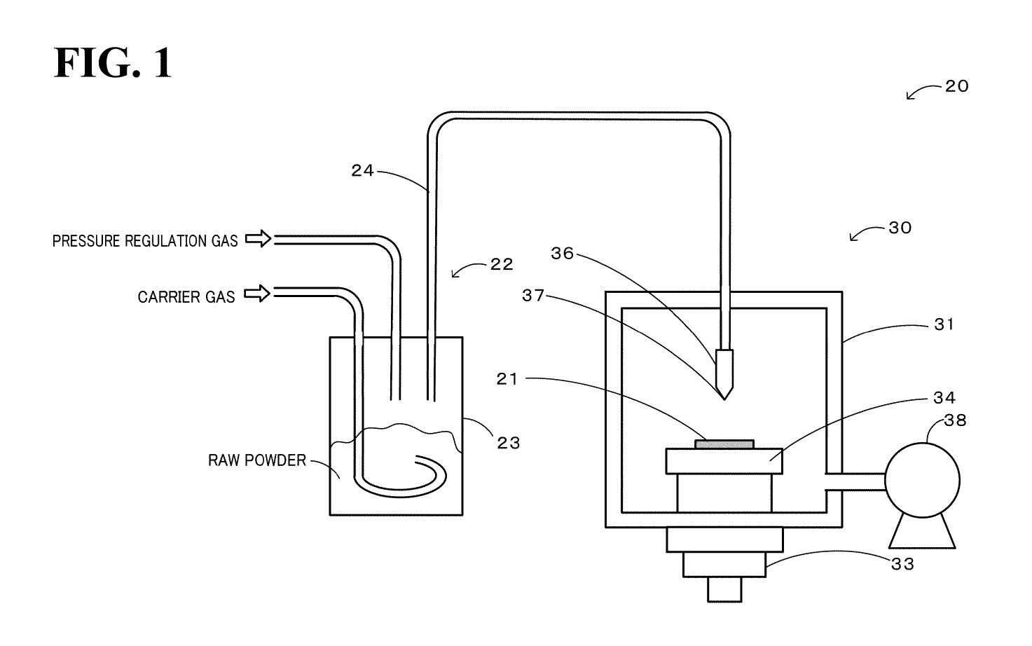

Layering using the aerosol deposition method can be performed using a multilayer body manufacturing apparatus 20 illustrated in FIG. 1, for example. The multilayer body manufacturing apparatus 20 is configured to be used for the aerosol deposition method (AD method) for spraying a substrate with a raw powder in an atmosphere having a pressure lower than atmospheric pressure. The multilayer body manufacturing apparatus 20 includes an aerosol generating unit 22 for generating an aerosol of a raw powder containing a raw material component and a film forming unit 30 for spraying a substrate 21 with the raw powder to form a film containing the raw material component. The aerosol generating unit 22 includes an aerosol generating chamber 23 for storing the raw powder and generating the aerosol in response to the supply of a carrier gas from a gas cylinder (not shown) and an aerosol supply pipe 24 for supplying the aerosol to the film forming unit 30. The aerosol generating chamber 23 is equipped with a vibrating and agitating unit (not shown) for vibrating the aerosol generating chamber 23 and is configured to mix the raw powder and the carrier gas by vibration and form an aerosol. The aerosol supply pipe 24 is equipped with a control valve for controlling the aerosol flow rate in the aerosol supply pipe 24 and is configured to control the amount of aerosol to be sprayed over the substrate 21. The film forming unit 30 includes a film forming chamber 31, which houses the substrate 21 and in which the aerosol is sprayed over the substrate 21 under reduced pressure, a substrate holder 34, which is disposed in the film forming chamber 31 and can hold the substrate 21, and an XYZθ stage 33, which includes an X-Y stage for moving the substrate holder 34 in the X-axis and Y-axis direction, a Z stage for moving the substrate holder 34 in the Z-axis direction, and a θ stage for moving the substrate holder 34 in the θ direction. The film forming unit 30 includes a spray nozzle 36, which has a rectangular slit 37 at the tip thereof and through which the aerosol is sprayed over the substrate 21, and a vacuum pump 38 for reducing the pressure of the film forming chamber 31.

(Method for Manufacturing Multilayer Body)

A method for manufacturing a multilayer body according to the present invention includes a layering step of successively layering two or more materials having different dielectric constants by using an aerosol deposition method for spraying a substrate with a raw powder in an atmosphere having a pressure lower than atmospheric pressure. The aerosol deposition method allows raw powders to be layered without deterioration in the characteristics of each raw powder. The aerosol deposition method requires no heat treatment and therefore facilitates the manufacture of a multilayer body that contains no glass in its materials and does not have a reaction layer formed by a reaction between the materials having different dielectric constants at an interface between the materials.

In the method for manufacturing a multilayer body according to the present invention, a raw powder of at least one of the two or more materials having different dielectric constants in the layering step has a core-shell structure. A raw powder having a core-shell structure can have greater functionality because the core and shell can have different functions. In such a method for manufacturing a multilayer body using a raw powder having a core-shell structure, the powder having the core-shell structure may have an average particle size of 100 nm or more and 5 μor less and a core particle size/shell particle size ratio of 0.1 or more and 0.9 or less. This allows the functions of the core and shell to be fully performed. The powder having a core-shell structure preferably has an average particle size of 0.3 μm or more and 3 μm or less, more preferably 0.5 μm or more and 2 μm or less. The powder having a core-shell structure preferably has a core particle size/shell particle size ratio of 0.2 or more and 0.8 or less, more preferably 0.3 or more and 0.7 or less. A method for manufacturing a multilayer body using a raw powder having a core-shell structure may include, before the layering step, a powder synthesis step of synthesizing a powder having a core-shell structure by adding one or more selected from the group consisting of alkaline-earth elements, rare earth elements, Ti, Sb, Ni, Cu, Cr, Fe, Co, Mn, Ta, Nb, W, Mb, Zn, and Bi to a BaTiO₃ powder and heat-treating the BaTiO₃ powder at a temperature of 500° C. or more and 1300° C. or less. A core-shell powder more suitable for the manufacture of a multilayer body according to the present invention can be synthesized in the powder synthesis step. The component(s) to be added to the BaTiO₃ powder maybe added as a single metal or as an alloy thereof. The component(s) to be added to the BaTiO₃ powder may also be added as an oxide or composite oxide or as a precursor compound that can produce an oxide or composite oxide by heat treatment. Among the components to be added to the BaTiO₃ powder in the powder synthesis step, Zn and Bi are more preferably added.

(Method for Manufacturing Powder)

A method for manufacturing a powder according to the present invention includes a powder synthesis step of synthesizing a powder having a core-shell structure by adding one or more selected from the group consisting of alkaline-earth elements, rare earth elements, Ti, Sb, Ni, Cu, Cr, Fe, Co, Mn, Ta, Nb, W, Mo, Zn, and Bi to a BaTiO₃ powder and heat-treating the BaTiO₃ powder at a temperature of 500° C. or more and 1300° C. or less. The component(s) to be added to the BaTiO₃ powder may be added as a single metal or as an alloy thereof. The component(s) to be added to the BaTiO₃ powder may also be added as an oxide or composite oxide or as a precursor compound that can produce an oxide or composite oxide by heat treatment. Among the components to be added to the BaTiO₃ powder in the powder synthesis step, Zn and Bi are more preferably added.

The multilayer body and the method for manufacturing a multilayer body described above can retain the dielectric properties of the raw materials of the multilayer body. The method for manufacturing a powder according to the present invention can manufacture a powder having a core-shell structure more suitable for the manufacture of a multilayer body.

The present invention is not limited to the embodiments described above and can be implemented in various aspects within the scope of the present invention.

### EXAMPLES

Specific examples of the manufacture of a multilayer body will be described below as examples. Experimental Examples 1 to 4 correspond to examples of the present invention, and Experimental Examples 5 and 6 correspond to comparative examples.

### Experimental Examples 1 to 4

### (Preparation of Raw Powders)

A BaCO₃ powder (manufactured by Sakai Chemical Industry Co., Ltd., high-purity barium carbonate 99.9%, average particle size 3 μ), a TiO₂ powder (manufactured by Kojundo Chemical Laboratory Co., Ltd., TIO13PB, average particle size 2 μm), an Al₂O₃ powder (manufactured by Iwatani Chemical Industry Co., Ltd., RA-40, average particle size 1 μm), a SiO₂ powder (manufactured by Tokuyama Corporation, Excelica SE-1, average particle size 0.5 μ), a ZnO powder (manufactured by Kojundo Chemical Laboratory Co., Ltd., ZNO02PB, average particle size 1 μm), a Bi₂O₃ powder (manufactured by Kojundo Chemical Laboratory Co., Ltd., BIO12PB, average particle size 7 μ), and a Nd₂O₃ powder (manufactured by Shin-Etsu Chemical Co., Ltd., average particle size 3 μ) were weighed so as to satisfy the component ratio of the ceramic A listed in Table 1 and were wet-blended using a pot made of polyethylene, zirconia balls, and isopropyl alcohol (IPA) as a solvent. The resulting slurry was dried to form a mixed powder. The mixed powder was charged into an alumina sheath and was heat-treated in the air in an electric furnace at 1100° C. for 2 hours to form a synthetic powder. The synthetic powder was pulverized to an average particle size of 0.5 μm in a wet process using a pot made of polyethylene, zirconia balls, and IPA as a solvent and was dried to form a raw powder of the ceramic A.

TABLE 1

| | Component of Ceramic A | | | | | | | |
|---|---|---|---|---|---|---|---|---|
| | | | | | | | | Amount |
| | | | | | | | | of Glass |
| | BaO | TiO₂ | Al₂O₃ | SiO₂ | ZnO | Bi₂O₃ | Nd₂O₃ | Added |
| | mol % | mol % | mol % | mol % | mol % | mol % | mol % | mass % |
| Experimental | 28.5 | 0 | 2.5 | 64.6 | 4.4 | 0 | 0 | 0 |
| Example 1 | | | | | | | | |
| Experimental | 11.2 | 55.1 | 0 | 0 | 33.7 | 0 | 0 | 0 |
| Example 2 | | | | | | | | |
| Experimental | 16 | 67.1 | 0 | 0 | 0 | 3 | 13.9 | 0 |
| Example 3 | | | | | | | | |
| Experimental | 16.8 | 58.4 | 0 | 0 | 0 | 7.3 | 17.5 | 0 |
| Example 4 | | | | | | | | |
| Experimental | 28.5 | 0 | 2.5 | 64.6 | 4.4 | 0 | 0 | 6 |
| Example 5 | | | | | | | | |
| Experimental | 28.5 | 0 | 2.5 | 64.6 | 4.4 | 0 | 0 | 0 |
| Example 6 | | | | | | | | |

A BaTiO₃ powder (manufactured by KCM Corporation, average particle size 0.4 μ), a ZnO powder (manufactured by Kojundo Chemical Laboratory Co., Ltd., ZNO02PB, average particle size 1 μ), a Bi₂O; powder (manufactured by Kojundo Chemical Laboratory Co., Ltd., BIO12PB, average particle size 7 μ), and a Mn₃O₄ powder (manufactured by Kojundo Chemical Laboratory Co., Ltd., MNO05PB, average particle size 7 μm) were weighed so as to satisfy the component ratio of the ceramic B listed in Table 2 and were wet-blended using a pot made of polyethylene, zirconia balls, and IPA as a solvent. The resulting slurry was dried to form a mixed powder. The mixed powder was charged into an alumina sheath and was heat-treated in the air in an electric furnace at 920° C. for 2 hours to form a synthetic powder. The synthetic powder was ground in a mortar, was pulverized to an average particle size of 0.5 μm in a wet process using a pot made of polyethylene, zirconia balls, and IPA as a solvent, and was dried to form a raw powder of the ceramic B. The raw material of the ceramic B synthesized using the BaTiO₃ powder had a core-shell structure in which the central portion of the powder was a core having the BaTiO₃ composition, and the periphery of the powder was a shell composed of BaTiO₃ partly substituted with Zn, Bi, and/or Mn and/or BaTiO₃ in which Zn, Bi, and/or Mn was dissolved. In this core-shell structure, the core had an average particle size of 0.25 μm, the shell had an average particle size of 0.5 μm, and the average core particle size/shell particle size ratio was 0.5. The structure was examined using FE-SEM by processing a synthetic powder embedded in a resin using a focused ion beam machining apparatus to form a cross section.

TABLE 2

| | Component of Ceramic B | | | | | |
|---|---|---|---|---|---|---|
| | | | | | | Amount |
| | | | | | | of Glass |
| | BaO | TiO₂ | ZnO | Bi₂O₃ | Mn₃O₄ | Added |
| | mol % | mol % | mol % | mol % | mol % | mass % |
| Experimental | 47.2 | 47.2 | 2.7 | 2.7 | 0.2 | 0 |
| Example 1 | | | | | | |
| Experimental | 47.2 | 47.2 | 2.7 | 2.7 | 0.2 | 0 |
| Example 2 | | | | | | |
| Experimental | 47.2 | 47.2 | 2.7 | 2.7 | 0.2 | 0 |
| Example 3 | | | | | | |
| Experimental | 47.2 | 47.2 | 2.7 | 2.7 | 0.2 | 0 |
| Example 4 | | | | | | |
| Experimental | 47.2 | 47.2 | 2.7 | 2.7 | 0.2 | 6 |
| Example 5 | | | | | | |
| Experimental | 50 | 50 | 0 | 0 | 0 | 0 |
| Example 6 | | | | | | |

(Manufacture of Multilayer Body)

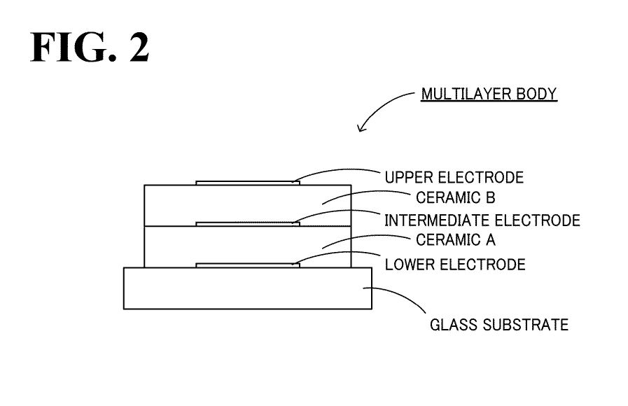

A multilayer body for use in the measurement of dielectric properties was formed using an AD method with a multilayer body manufacturing apparatus 20 illustrated in FIG. 1 by successively depositing a Ag powder (0.5 μm, the same applies hereinafter), the raw powder of the ceramic A, the Ag powder, the raw powder of the ceramic B, and the Ag powder on a glass substrate. A ceramic nozzle having a slit 10 mm in length and 0.4 mm in width was used as a nozzle. A 19.6-Pa high-purity nitrogen gas (purity 99.9%) was used as a carrier gas. The flow rate of the carrier gas for forming an aerosol was set at 4 L/min. The film forming chamber was maintained at a pressure in the range of 5 to 10 Pa. Each aerosol powder was sprayed. In this manner, a multilayer body of glass substrate/lower electrode (Ag, 1 μm)/ceramic A (15 μm)/intermediate electrode (Ag, 1 μm)/ceramic B (15 μm)/upper electrode (Ag, 1 μm) was manufactured. FIG. 2 is a schematic cross-sectional view of the multilayer body. The multilayer body was processed into a multilayer body for use in measurement by forming a via extending from an electrode.

### Experimental Example 5

### (Preparation of Raw Material Powder)

A BaCO₃ powder (manufactured by Sakai Chemical Industry Co., Ltd., high-purity barium carbonate 99.9%, average particle size 3 μm), an Al₂O₃ powder (manufactured by Iwatani Chemical Industry Co., Ltd., RA-40, average particle size 1 μ), a SiO₂ powder (manufactured by Tokuyama. Corporation, Excelica SE-1, average particle size 0.5 μm), and a ZnO powder (manufactured by Kojundo Chemical Laboratory Co., Ltd., ZNO02PB, average particle size 1 μm) were weighed so as to satisfy the component ratio of the ceramic A listed in Table 1 and were wet-blended using a pot made of polyethylene, zirconia balls, and isopropyl alcohol (IPA) as a solvent. The resulting slurry was dried to form a mixed powder. The mixed powder was charged into an alumina sheath and was heat-treated in the air in an electric furnace at 1100° C. for 2 hours to form a synthetic powder. The synthetic powder was pulverized to an average particle size of 0.5 μm in a wet process using a pot made of polyethylene, zirconia balls, and IPA as a solvent. After drying, a predetermined amount of Ba—Al—Si—O glass listed in Table 1 was added to the synthetic powder to form a raw powder of the ceramic A.

A BaTiO₃ powder (manufactured by KCM Corporation, average particle size 0.4 μm), a ZnO powder (manufactured by Kojundo Chemical Laboratory Co., Ltd., ZNO02PB, average particle size 1 μm), a Bi₂O₃ powder (manufactured by Kojundo Chemical Laboratory Co., Ltd., BIO12PB, average particle size 7 μ), and a Mn₃O₄ powder (manufactured by Kojundo Chemical Laboratory Co., Ltd., MNO05PB, average particle size 7 μm) were weighed so as to satisfy the component ratio of the ceramic B listed in Table 2 and were wet-blended using a pot made of polyethylene, zirconia balls, and IPA as a solvent. The resulting slurry was dried to form a mixed powder. The mixed powder was charged into an alumina sheath and was heat-treated in the air in an electric furnace at 920° C. for 2 hours to form a synthetic powder. The synthetic powder was pulverized to an average particle size of 0.5 μin a wet process using a pot made of polyethylene, zirconia balls, and IPA as a solvent. After drying, a predetermined amount of Zn—Si—B—O glass listed in Table 2 was added to the synthetic powder to form a raw powder of the ceramic B.

(Preparation of Multilayer Body)

Each of the raw powders thus prepared was mixed with an organic binder, a plasticizer, a dispersant, and an organic solvent in a ball mill to form a slurry. The slurry was used to form a green sheet having a thickness of 0.02 mm using a doctor blade device. A green sheet multilayer body was formed in a structure that included the green sheets of the ceramic B with the green sheet of the ceramic A interposed therebetween, and a capacitor layer was formed at a portion of the ceramic A and a portion of the ceramic B by forming an electrode pattern by screen printing using a Ag powder paste in advance. The green sheet multilayer body was sintered in the ambient atmosphere at 920° C. for 2 hours to form a multilayer body. The overlap area of the electrodes after firing was 2 mm². The multilayer body was processed into a multilayer body for use in measurement by forming a via extending from an electrode.

### Experimental Example 6

A multilayer body was manufactured in the same manner as in Experimental Example 1 except that the raw powder of the ceramic B was not synthesized, and a BaTiO₃ powder (manufactured by KCM Corporation, average particle size 0.4 μm) was used.

Evaluation

The room-temperature dielectric constant at 1 kHz, the temperature coefficient of the dielectric constant, and the room-temperature tans were measured in the multilayer bodies according to Experimental Examples 1 to 6. An impedance analyzer was used in the measurement. Table 3 shows the results. Experimental Examples 1 to 4 had a low dielectric loss tangent tans because of the absence of glass. In Experimental Example 6, the ceramic B had a high dielectric loss tangent tans in spite of the absence of glass. This was probably because a lattice defect was introduced into the BaTiO₃ during the film formation using the AD method. In Experimental Examples 1 to 4, in which the AD method using the raw powder having a core-shell structure as the raw powder of the ceramic B was used for layering, the ceramic layer B advantageously had a high dielectric constant and a low temperature coefficient. A cross section of each of the multilayer bodies according to Experimental Examples 1 to 6 was observed using FE-SEM. It was found that no reaction layer was formed between the ceramic A and the ceramic B, between the ceramic A and the Ag electrode, and between the ceramic B and the Ag electrode. In the multilayer bodies according to Experimental Examples 1 to 4, the ceramic B had the core-shell structure, and the aspect ratio of the shell was higher than the aspect ratio of the core.

TABLE 3

| | Properties of Ceramic A | | | Properties of Ceramic B | | | |
|---|---|---|---|---|---|---|---|
| | | Dielectric | | | Dielectric | Temperature | |
| | | Constant | tan δ | | Constant | Coeffiecient^{} | tan δ |
| | Composition | — | — | Composition | — | % | — |
| Experimental | BaO—Al₂O₃—SiO₂—ZnO | 7 | 0.0004 | BaO—TiO₂—ZnO—Bi₂O₃—Mn₃O₄ | 1200 | 14 | 0.014 |
| Example 1 | | | | | | | |
| Experimental | BaO—TiO₂—ZnO | 25 | 0.0004 | BaO—TiO₂—ZnO—Bi₂O₃—Mn₃O₄ | 1200 | 14 | 0.014 |
| Example 2 | | | | | | | |
| Experimental | BaO—TiO₂—Bi₂O₃—Nd₂O₃ | 80 | 0.002 | BaO—TiO₂—ZnO—Bi₂O₃—Mn₃O₄ | 1200 | 14 | 0.014 |
| Example 3 | | | | | | | |
| Experimental | BaO—TiO₂—Bi₂O₃—Nd₂O₃ | 120 | 0.009 | BaO—TiO₂—ZnO—Bi₂O₃—Mn₃O₄ | 1200 | 14 | 0.014 |
| Example 4 | | | | | | | |
| Experimental | BaO—Al₂O₃—SiO₂—ZnO + | 9 | 0.001 | BaO—TiO₂—ZnO—Bi₂O₃—Mn₃O₄ + | 850 | 30 | 0.04 |
| Example 5 | Glass Component | | | Glass Component | | | |
| Experimental | BaO—Al₂O₃—SiO₂—ZnO | 7 | 0.0004 | BaO—TiO₂ | 800 | 200 | 0.07 |
| Example 6 | | | | | | | |

^{}Measurerd at 25° C.

The present application claims priority from U. S. Provisional Application No. 61/935,426 filed on Feb. 4, 2014, the entire contents of which are incorporated herein by reference.

What is claimed is:

1. A multilayer body, in which two or more materials having different dielectric constants are stacked, at least one of the two or more materials having different dielectric constants is composed of particles having a core-shell structure, and the multilayer body being free of glass.

2. The multilayer body according to claim 1, wherein no reaction layer is formed at an interface between the materials having different dielectric constants by a reaction between the materials.

3. The multilayer body according to claim 1, wherein a first material having a first dielectric constant of 1000 or more and a second material having a second dielectric constant that is lower than the first dielectric constant are stacked.

4. The multilayer body according to claim 3, wherein the first material is a BaTiO₃ material, and the second material is composed of one or more selected from the group consisting of BaO—TiO₂—ZnO materials, BaO—TiO₂—Bi₂O₃—Nd₂O₃ materials, and BaO—Al₂O₃—SiO₂—ZnO materials.

5. The multilayer body according to claim 1, wherein the core of the core-shell structure has a lower aspect ratio than the shell of the core-shell structure.

6. The multilayer body according to claim 1, wherein a first material having a first dielectric constant of 1000 or more and a second material having a second dielectric constant that is lower than the first dielectric constant are stacked, the first material is composed of particles having a core-shell structure, and the shell of the core-shell structure contains one or more selected from the group consisting of alkaline-earth metal elements, rare earth elements, Ti, Sb, Ni, Cu, Cr, Fe, Co, Mn, Ta, Nb, W, Mo, Zn, and Bi.

7. The multilayer body according to claim 1, wherein the core-shell structure has a core composed of BaTiO₃ and a shell composed of BaTiO₃ partly substituted with one or more selected from the group consisting of alkaline-earth metal elements, rare earth elements, Ti, Sb, Ni, Cu, Cr, Fe, Co, Mn, Ta, Nb, W, Mo, Zn, and Bi and/or BaTiO₃ in Which one or more selected from the group consisting of alkaline-earth metal elements, rare earth elements, Ti, Sb, Ni, Cu, Cr, Fe, Co, Mn, Ta, Nb, W, Mo, Zn, and Bi is dissolved.

8. The multilayer body according to claim 1, further comprising an electrically conductive layer.

9. The multilayer body according to claim 8, wherein the electrically conductive layer contains one or more selected from the group consisting of Ni, Cu, Ag, Pd, Au, and Al.

10. The multilayer body according to claim 1, manufactured by using an aerosol deposition method for spraying a substrate with a raw powder in an atmosphere having a pressure lower than atmospheric pressure.

11. A method for manufacturing a multilayer body, comprising: a layering step of successively layering two or more materials having different dielectric constants by using an aerosol deposition method for spraying a substrate with a raw powder in an atmosphere having a pressure lower than atmospheric pressure, wherein a raw powder of at least one of the two or more materials having different dielectric constants in the layering step has a core-shell structure.

12. The method for manufacturing a multilayer body according to claim 11, wherein the powder having the core-shell structure has an average particle size of 100 nm or more and 5 μm or less and a core particle size/shell particle size ratio of 0.1 or more and 0.9 or less.

13. The method for manufacturing a multilayer body according to claim 11, further comprising: a powder synthesis step of synthesizing the powder having a core-shell structure by adding one or more selected from the group consisting of alkaline-earth elements, rare earth elements, Ti, Sb, Ni, Cu, Cr, Fe, Co, Mn, Ta, Nb, W, Mo, Zn, and Bi to a BaTiO₃ powder and heat-treating the BaTiO₃ powder at a temperature of 500° C. or more and 1300° C. or less.

14. A method for manufacturing a powder, comprising: a powder synthesis step of synthesizing a powder having a core-shell structure by adding one or more selected from the group consisting of alkaline-earth elements, rare earth elements, Ti, Sb, Ni, Cu, Cr, Fe, Co, Mn, Ta, Nb, W, Mo, Zn, and Bi to a BaTiO₃ powder and heat-treating the BaTiO₃ powder at a temperature of 500° C. or more and 1300° C. or less.
